(19) United States
(12) Patent Application Publication
(10) Pub. No.: US 2023/0280281 A1
(43) Pub. Date: Sep. 7, 2023

(54) DEFECT DETECTION METHOD AND DEFECT DETECTION SYSTEM BASED ON MACHINE VISION

(71) Applicant: Chongqing University of Technology, Chongqing (CN)

(72) Inventors: Zengzhen MI, Chongqing (CN); Chao CONG, Chongqing (CN)

(21) Appl. No.: 17/932,380

(22) Filed: Sep. 15, 2022

(30) Foreign Application Priority Data
Mar. 4, 2022 (CN) 202210214330.5

(51) Int. Cl. G01N 21/90; B65G 47/38; G01N 21/88

(52) U.S. Cl. CPC G01N 21/9018; B65G 47/38; G01N 21/8851

(57) ABSTRACT

A defect detection system based on machine vision includes a monitoring module, a detection module, an early warning module, and a screening module. A method and the system are implemented by timely screening out an empty bottle having a different specification in detection, monitoring whether a content in each of empty bottles meets requirement, monitoring whether foreign matter is contained in each of filled bottles, and displaying a monitored image on a display device. Bottles that are normal in the detection are filled, filled bottles are monitored through the monitoring module. The monitoring module is configured to monitor whether the content in the filled bottles meets requirement, whether foreign matter is contained in the filled bottles.

### CROSS REFERENCE TO RELATED APPLICATION

The present application claims the benefit and priority of Chinese Patent Application No. 202210214330.5, entitled “DEFECT DETECTION METHOD AND DEFECT DETECTION SYSTEM BASED ON MACHINE VISION” filed on Mar. 4, 2022, the disclosure of which is incorporated by reference herein in its entirety as part of the present application.

### TECHNICAL FIELD

The present disclosure relates to the technical field of machine defect detection, and in particular to a defect detection method and a defect detection system based on machine vision.

### BACKGROUND ART

Plastic bottles are mainly made of materials such as polyethylene (PE) or polypropylene (PP) with the addition of various organic solvents. The plastic bottles are plastic containers manufactured by widely taking polyester (PET), PE and PP as raw materials, adding corresponding organic solvents, heating at a high temperature, and performing blow molding, extrusion blow molding (EBM) or injection molding through a plastic mold. The plastic bottles are mainly used as disposable plastic packaging containers for liquids or solids such as beverages, foods, pickles, honey, dried fruits, edible oils, agricultural and veterinary drugs, and have the characteristics of being not easy to break, low cost, high transparency, food-grade raw materials, etc. Beverage bottles in use often undergo multiple detections. However, existing beverage bottles are not enough accurate in the detection on cleaning before use and a beverage amount in the bottles after use. In view of this, a defect detection method and a defect detection system based on machine vision are provided for detecting use of beverage bottles.

### SUMMARY

### I. Technical Problems to be Solved

In view of shortages in the prior art, the present disclosure provides a defect detection method and a defect detection system based on machine vision. The present disclosure advantageously includes detecting beverage bottles with high-definition cameras, and providing a screening device to screen out an unqualified product timely, thereby solving the existing problems of inaccurate detection on cleaning before use and a beverage amount in the bottles after use.

### II. Technical Solutions

To achieve the above objects, the present disclosure provides the following technical solutions: a defect detection method and a defect detection system based on machine vision, wherein the defect detection system includes a monitoring module, a detection module, an early warning module, and a screening module,

the detection module is configured to detect whether empty bottles are clean, and whether residue is present in the empty bottles;

the detection module is further configured to inspect specifications of the empty bottles, and have a different empty bottle with a different specification than that of other empty bottles screened out timely when the different empty bottle is found during inspection;

the monitoring module is configured to monitor filled bottles that have been filled with a beverage, and the monitoring module is configured to monitor whether contents in the bottles meet a requirement, and whether foreign matter is contained in the filled bottles;

a monitored image is displayed on a display device through an imager;

the screening module is configured to screen out the different empty bottle with the different specification and the filled bottles having a content not meeting the requirement;

the defect detection system is configured for: detecting the empty bottles, in order to detect whether the empty bottles are clean, and whether residue is present in the empty bottles;

inspecting specifications of the bottles, in order that the different bottle with the different specification is screened out by the screening module;

monitoring beverage contents in the filled bottles that have been filled with a beverage, to monitor whether contents in the filled bottles meet a requirement, and whether foreign matter enters the filled bottles during filling; and

displaying a monitored object visually on the display device.

Preferably, the monitoring module can include a first camera, a second camera, the imager, and the display device, the first camera is located at an upper portion of a bottle body, and the second camera is located at a lower portion of the bottle body; real-time data received through a data access function is superimposed to a real-time video stream of a video image, and various data information pushed by a third-party platform, or data shared in a real-time database is displayed on a monitoring picture, so that it is convenient in a daily or malfunctional time, detailed information of a site is known clearly by observing the images and the superimposed data.

Preferably, the detection module can include a third camera, which can be a movable camera; the third camera can be electrically connected with a display screen; the detection module can be electrically connected to the screening module; and the detection module shoots the empty bottles with the third camera, thereby detecting whether the foreign matter is contained in the empty bottles.

Preferably, the early warning module is electrically connected to the monitoring module, the early warning module includes an early warning signal light and an early warning bell, and the early warning module gives an alarm timely when the monitoring module monitors an abnormal liquid content in the filled bottle, thereby facilitating people to find out.

Preferably, the screening module is configured to screen out an unqualified bottle during product detection process, and further screen out an unqualified product after having bottles filled. The screening module serves for screening out an unqualified product, thereby ensuring product quality.

Preferably, the defect detection method includes the following steps:

S101: placing empty bottles onto a conveyor belt for detection;

S102: transmitting a scanned image by a third camera to a display screen to display status of the empty bottles, and observing whether foreign matter is contained in the empty bottles;

S103: screening out a bottle containing foreign matter therein by a screening module if foreign matter is contained in the bottle;

S104: filling bottles that are normal in detection;

S105: monitoring filled bottles by a monitoring module, where cameras in the monitoring module monitor a height of a solution in each of the filled bottles;

S106: screening out timely an unqualified bottle having a solution level lower than a certain height found in Step S105, thereby ensuring that the height of the solution in each of remaining filled bottles falls within a certain range.

Preferably, the defect detection method and the defect detection system detect the beverage bottles from various orientations, with scanning of the cameras and in cooperation with an early warning system, and give an early warning timely when an abnormity is found, thus to ensure that the beverage bottles filled with the beverage meet a use standard.

The defect detection method and defect detection system based on machine vision provided according to the present disclosure have the following beneficial effects over the prior art:

1) According to the defect detection method and defect detection system based on machine vision, empty bottles are placed onto a conveyor belt for detection. A scanned image is transmitted by a third camera to a display screen to display status of the empty bottles. A detection module is configured to detect whether the empty bottles are clean, and whether a residue is present in the empty bottles, as well as observe whether foreign matter is contained in the empty bottles, and have a bottle screened out in cooperation with a screening module if foreign matter is contained.

2) According to the defect detection method and the defect detection system based on machine vision, bottles that are normal in detection are filled. Filled bottles are monitored by a monitoring module. The monitoring module is configured to monitor whether content in each of the bottles meets a requirement, and whether the foreign matter is contained in the bottles. Cameras in the monitoring module inspect a height of a solution in each of the bottles, and an unqualified bottle having the solution level lower than a certain height is timely screened out, thereby ensuring that the height of the solution in each of remaining filled bottles falls within a certain range, and the product meets a standard.

### BRIEF DESCRIPTION OF THE DRAWING

FIG. 1 is a flow chart of a defect detection method based on machine vision in accordance with the present disclosure.

### DETAILED DESCRIPTION OF THE EMBODIMENTS

The technical solutions in the embodiments of the present disclosure will be clearly and completely described below. Apparently, the described embodiments are merely a part of, not all of the embodiments of the present disclosure. All other embodiments obtained by those of ordinary skill in the art based on the embodiments of the present disclosure without creative efforts shall fall within the protection scope of the present disclosure.

A defect detection method and a defect detection system based on machine vision are provided, wherein the defect detection system includes a monitoring module, a detection module, an early warning module, and a screening module.

The detection module is configured to detect whether empty bottles are clean, and whether residue is present in the empty bottles.

The detection module is further configured to inspect specifications of the empty bottles, and timely have a different empty bottle with a different specification screened out when the different empty bottle is found during inspection.

The monitoring module is configured to monitor filled bottles that have been filled with a beverage. The monitoring module is configured to monitor whether contents in the bottles meet a requirement, and whether foreign matter is contained in the filled bottles.

A monitored image is displayed on a display device through an imager.

The screening module is configured to screen out the different empty bottle with the different specification and the filled bottles having a content not meeting the requirement.

The defect detection system is configured for: detecting the empty bottles, in order to detect whether the empty bottles are clean, and whether residue is present in the empty bottles.

Then inspecting specifications of the bottles, in order that the different bottle with the different specification is screened out by the screening module.

Monitoring beverage contents in the filled bottles that have been filled with a beverage to monitor whether contents in the filled bottles meet a requirement, and whether foreign matter enters the filled bottles during filling.

Displaying a monitored object visually on the display device.

Preferably, the monitoring module includes a first camera, a second camera, the imager, and the display device. The first camera is located at an upper portion of a bottle body, and the second camera is located at a lower portion of the bottle body. Real-time data received through a data access function is superimposed to a real-time video stream of a video image, and various data information pushed by a third-party platform, or data shared in a real-time database is displayed on a monitoring picture, so that it is convenient in a daily or malfunctional time, detailed information of a site is known clearly by observing the images and the superimposed data.

Preferably, the detection module includes a third camera. The third camera is a movable camera. The third camera is electrically connected with a display screen. The detection module is electrically connected to the screening module. The detection module shoots the empty bottles with the third camera, thereby detecting whether foreign matter is contained in the empty bottles.

Preferably, the early warning module is electrically connected to the monitoring module. The early warning module includes an early warning signal light and an early warning bell. The early warning module gives an alarm timely when the monitoring module monitors an abnormal liquid content in the filled bottle, facilitating people to find out.

Preferably, the screening module is configured to screen out an unqualified bottle during product detection process, and further screen out an unqualified product after having the bottles filled. The screening module serves for screening out an unqualified product, thereby ensuring product quality.

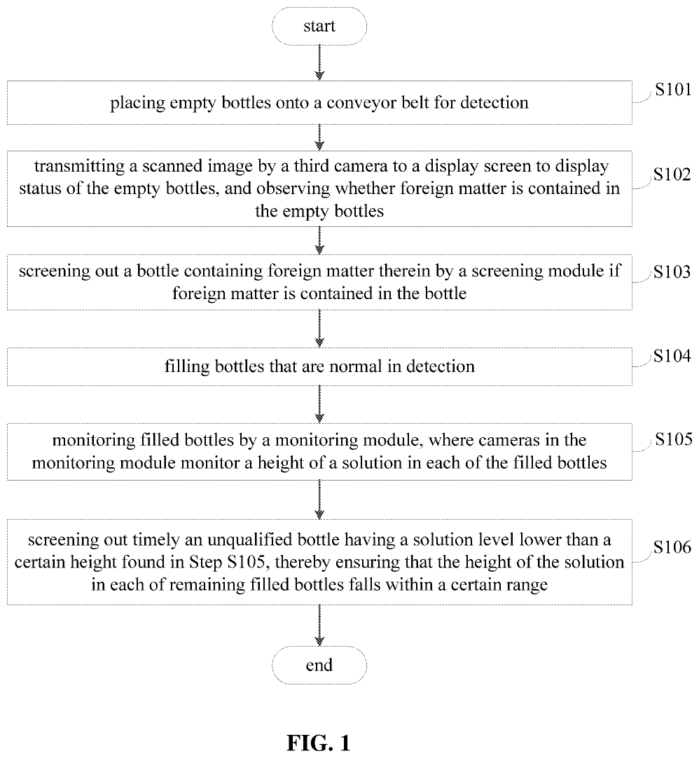

As shown in FIG. 1, a defect detection method includes the following steps:

S101: placing empty bottles onto a conveyor belt for detection;

S102: transmitting a scanned image by a third camera to a display screen to display status of the empty bottles, and observing whether foreign matter is contained in the empty bottles;

S103:screening out a bottle containing foreign matter therein by a screening module if foreign matter is contained in the bottle;

S104: filling bottles that are normal in detection; S105:monitoring filled bottles by a monitoring module, where cameras in the monitoring module monitor a height of a solution in each of the filled bottles;

S106: screening out timely an unqualified bottle having the solution level lower than a certain height found in Step S105, thereby ensuring that the height of the solution in each of remaining filled bottles falls within a certain range.

Preferably, the defect detection method and the defect detection system detect the beverage bottles from various orientations, with scanning of the cameras and in cooperation with an early warning system, and give an early warning timely when an abnormity is found, thus to ensure that the beverage bottles filled with the beverage meet a use standard.

The operation principle is as follows. When the defect detection method and defect detection system based on machine vision are used, empty bottles are placed onto a conveyor belt for detection. A scanned image is transmitted by a third camera to a display screen to display status of the empty bottles. A detection module is used to detect whether the empty bottles are clean, and whether a residue is present in each of the empty bottles, as well as observe whether foreign matter is contained in each of the empty bottles, and screen out a bottle in cooperation with a screening module if foreign matter is observed in the empty bottle. Then, bottles that are normal in detection are filled. Filled bottles are monitored by a monitoring module. The monitoring module is used to monitor whether content in each of the bottles meets a requirement, and whether the foreign matter is contained in the bottle. Cameras of the monitoring module inspect a height of a solution in each of the bottles, and an unqualified bottle having the solution level lower than a certain height is timely screened out when the unqualified bottle is found, thereby ensuring that the height of the solution in each of remaining filled bottles falls within a certain range, and the product meets a standard.

Although the embodiments of the present disclosure have been illustrated and described, it should be understood that those of ordinary skill in the art can make various changes, modifications, replacements and variations to the above embodiments without departing from the principle and spirit of the present disclosure, and the scope of the present disclosure is limited by the appended claims and their legal equivalents.

1. A defect detection system based on machine vision, comprising a monitoring module, a detection module, an early warning module, and a screening module,
wherein the detection module is configured to detect whether empty bottles are clean, and whether residue is present in the empty bottles; the detection module is further configured to inspect specifications of the empty bottles, and have a different empty bottle with a different specification than that of other empty bottles screened out timely when the different empty bottle is found during inspection;
wherein the monitoring module is configured to monitor filled bottles that have been filled with a beverage, and the monitoring module is configured to monitor whether contents in the bottles meet a requirement, and whether foreign matter is contained in the filled bottles; a monitored image is displayed on a display device by an imager;
wherein the screening module is configured to screen out the different empty bottle with the different specification and the filled bottles having a content not meeting the requirement; and
wherein the defect detection system is configured for: detecting the empty bottles, in order to detect whether the empty bottles are clean, and whether residue is present in the empty bottles; inspecting specifications of the bottles, in order that the different bottle with the different specification is screened out by the screening module; monitoring beverage contents in the filled bottles that have been filled with a beverage, to monitor whether contents in the filled bottles meet a requirement, and whether foreign matter enters the filled bottles during filling; and displaying a monitored object visually on the display device.

2. The defect detection system based on machine vision according to claim 1, wherein the monitoring module comprises a first camera, a second camera, the imager, and the display device, the first camera is located at an upper portion of a bottle body, and the second camera is located at a lower portion of the bottle body; real-time data received through a data access function is superimposed to a real-time video stream of a video image, and various data information pushed by a third-party platform, or data shared in a real-time database is displayed on a monitoring picture.

3. The defect detection system based on machine vision according to claim 1, wherein the detection module comprises a third camera which is a movable camera, the third camera is electrically connected with a display screen, the detection module is electrically connected to the screening module; and the detection module shoots the empty bottles with the third camera, thereby detecting whether the foreign matter is contained in the empty bottles.

4. The defect detection system based on machine vision according to claim 1, wherein the early warning module is electrically connected to the monitoring module, the early warning module comprises an early warning signal light and an early warning bell, and the early warning module gives an alarm timely when the monitoring module monitors an abnormal liquid content in the filled bottles.

5. The defect detection system based on machine vision according to claim 1, wherein the screening module is configured to screen out an unqualified bottle during product detection process, and further screen out an unqualified product after having bottles filled.

6. A defect detection method based on machine, comprising the following steps:
S101: placing empty bottles onto a conveyor belt for detection;
S102: transmitting a scanned image by a third camera to a display screen to display status of the empty bottles, and observing whether foreign matter is contained in the empty bottles;
S103: screening out a bottle containing foreign matter therein by a screening module if foreign matter is contained in the bottle;
S104: filling bottles that are normal in detection;
S105: monitoring filled bottles by a monitoring module, where cameras in the monitoring module monitor a height of a solution in each of the filled bottles; and
S106: screening out timely an unqualified bottle having a solution level lower than a certain height found in Step S105, thereby ensuring that the height of the solution in each of remaining filled bottles falls within a certain range.

7. The defect detection method based on machine vision according to claim 6, wherein the defect method comprises detecting beverage bottles from various orientations, with scanning of the cameras and in cooperation with an early warning system, and give an early warning timely when an abnormity is found, to ensure that the beverage bottles filled with beverage meet a use standard.
